(19) United States
(12) Patent Application Publication
(10) Pub. No.: US 2026/0289562 A1
(43) Pub. Date: Sep. 24, 2026

(54) SYSTEM AND METHOD FOR ENABLING BLOCKCHAIN BASED TRANSACTION AUTHORIZATION

(71) Applicants: Vipul SAINI, Delhi (IN); HODL TECH PRIVATE LIMITED, Singapore (SG)

(72) Inventors: Vipul SAINI, Delhi (IN); Rohan Hari AGARWAL, Delhi (IN); Ujjwal KUMAR, Danapur (IN)

(21) Appl. No.: 19/476,057

(22) PCT Filed: Apr. 16, 2024
(86) PCT No.: PCT/IB2024/053710

§ 371 Date: Oct. 16, 2025

(30) Foreign Application Priority Data
Apr. 17, 2023 (IN) 202311028021

(51) Int. Cl. G06Q 20/40; G06Q 20/38; H04L 9/32

(52) U.S. Cl. CPC G06Q 20/401; G06Q 20/389; H04L 9/3247

(57) ABSTRACT

The present disclosure relates to a system and a method for enabling blockchain based transaction authorization. The system includes an authenticating device to receive a request for transaction authorization from a terminal device, where the request includes a plurality of credentials pertaining to transaction information, The authenticating device autonomously generates a first component and a second component of a digital signature, based on the plurality of credentials. The authenticating device encapsulates the second component into one or more discretionary data fields of a data object. The authenticating device generates a digital signature by combining the first component and the encapsulated second component. The authenticating device authorizes and transmits the digital signature to the terminal device to determine a status of a transaction, and receives the status of the transaction from the terminal device.

### TECHNICAL FIELD

The embodiments of the present disclosure generally relate to electronic transactions. More particularly, the present disclosure relates to a system and a method for enabling blockchain based transaction authorization which effectively permits distributed ledger transactions.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, Europay, Mastercard, and Visa (EMV) is a global standard for smart cards, i.e., credit and debit card transactions. An EMV protocol specifies an interaction between an EMV-enabled card and an EMV-enabled terminal during a transaction. The EMV protocol includes several steps which may include, but not limited to, a card authentication, a cardholder verification, a transaction authorization, a transaction completion, and the likes.

Transactional devices adapt a traditional infrastructure which implements technological protocols like the EMV standard. The technological protocols are utilized to complete the transaction when a Point-of-Sale (POS) terminal equipment is in contact with a smart payment card. The transaction authorization is performed along with a corresponding issuing entity, an acquiring entity, and a processing service. However, the EMV standards are restricted or limited to a set of defined fields, thereby the EMV standards do not support the fields and data required for Distributed ledger technologies (DLT) transaction authorization. Further, the EMV protocol does not provide a sufficient discretionary field size to encapsulate the DLT transaction and authorization fields.

Therefore, the transactions utilizing a distributed ledger, for example, a blockchain cannot be completed using the technical protocols like the EMV standard in their default configuration. This may be due to the technical protocol's discretionary data fields (such as tags) not being specifically designed to hold the DLT data or because of a size limitation that hinders interoperability. For example, a full transaction in Ethereum blockchain has a size of at least 110 bytes including a 64-byte signature. Neither the transaction nor the signature can fit into 32 bytes of unused space in EMV protocol. So, if a user attempts to transfer assets in the distributed ledger using the smart payment card through the POS terminal, the POS terminal may either fail to recognize the transaction or may produce an error message.

In addition, launching an advanced technical protocol is time consuming, because the technical protocols like the EMV standard are well-established in a bank related transaction sector and it is not feasible to establish a new protocol. As a result, it is necessary to improve the technical protocol without affecting its basis.

Existing solutions in the targeted field of application, attempt to solve the size limit of discretionary fields by limiting a value associated with the transaction and/or periodic syncing of an authenticating device. As a result, a practical limit is applied on a number of authorizations possible and/or the transaction value associated with a single update on the authenticating device. The practical limit on the number of transactions achievable after the single synchronization is restrictive for the users and introduces unnecessary complexity.

There is, therefore, a need in the art to provide an improved system and method for enabling transaction authorization by overcoming the shortcomings of the existing prior art(s).

### OBJECTS OF THE PRESENT DISCLOSURE

Some of the objects of the present disclosure, which at least one embodiment herein satisfies are as listed herein below.

An object of the present disclosure is to provide a system and a method for enabling blockchain based transaction authorization, which offers remote access, control, and authorization to smart cards using a Distributed Ledger Technology (DLT).

An object of the present disclosure is to provide a system and a method that empowers users to authorize multiple payment authorizations without a need to synchronize an authenticating device.

An object of the present disclosure is to provide feasibility to enable support for multiple user account identifiers on a single authenticating device.

An object of the present disclosure is to provide a system and a method that empowers users to choose and switch between DLTs.

An object of the present disclosure is to effectively permit distributed ledger transactions and reduce Point-of-Sale (POS) terminal error warnings.

An object of the present disclosure is to provide a cost-effective and time-effective solution for enabling blockchain based transaction authorization.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for enabling blockchain based transaction authorization. The system includes an authenticating device including one or more processors and a memory operatively coupled to the one or more processors. The memory includes processor-executable instructions, which on execution, cause the one or more processors to receive a request for transaction authorization from a terminal device, where the request includes a plurality of credentials pertaining to transaction information. The one or more processors autonomously generate at least a first component and a second component of a digital signature, based on the plurality of credentials. The one or more processors encapsulate the second component into one or more discretionary data fields of a data object, and generate the digital signature by combining the first component and the encapsulated second component. Further, the one or more processors authorize and transmit the digital signature to the terminal device to determine a status of a transaction. The one or more processors receive the status of the transaction from the terminal device.

In an embodiment, the one or more processors may receive the request for transaction authorization from the terminal device in response to establishing a connection between the authenticating device and the terminal device.

In an embodiment, the authenticating device may be made configurable to support an Europay, Mastercard, and Visa (EMV) standard that defines an electronic protocol to enable the transaction authorization.

In an embodiment, the plurality of credentials may include a plurality of data object values indicative of the transaction information, and seed data for autonomously generating at least the first component and the second component of the digital signature. The seed data may be stored in a database associated with the authenticating device.

In an embodiment, the one or more processors may authorize the digital signature by being configured to process and verify the digital signature, via a verification service, based on information received during configuration of the authenticating device.

In an embodiment, the one or more processors may transmit the digital signature to the terminal device by being configured to transmit the digital signature to at least one online service and enable the at least one online service to transmit the digital signature to the terminal device.

In an embodiment, the data object may be compatible with an EMV technical protocol.

In an embodiment, the first component may be a r-component, and the second component may be one of a s-component, an authorization cryptogram, or an authorization token.

In an embodiment, the digital signature may be transmitted to the at least one online service via a communication channel.

In an aspect, the present disclosure relates to a method for enabling blockchain based transaction authorization. The method includes receiving, by one or more processors associated with an authenticating device, a request for transaction authorization from a terminal device, where the request includes a plurality of credentials pertaining to transaction information. The method includes autonomously generating, by the one or more processors, at least a first component and a second component, based on the plurality of credentials. The method includes encapsulating, by the one or more processors, the second component into one or more discretionary data fields of a data object. The method includes generating, by the one or more processors, a digital signature by combining the first component and the encapsulated second component. The method includes authorizing and transmitting, by the one or more processors, the digital signature to the terminal device to determine a status of a transaction. The method includes receiving, by the one or more processors, the status of the transaction from the terminal device.

### BRIEF DESCRIPTION OF DRAWINGS

The accompanying drawings, which are incorporated herein, and constitute a part of this invention, illustrate exemplary embodiments of the disclosed methods and systems which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that the invention of such drawings includes the invention of electrical components, electronic components or circuitry commonly used to implement such components.

FIG. 1 illustrates an example block diagram of a system 100 for enabling blockchain based transaction authorization, in accordance with an embodiment of the present disclosure.

FIG. 2 illustrates an exemplary block diagram of a system 100 for enabling blockchain based transaction authorization based on a verification of an authenticating device by relying on a user device, in accordance with an embodiment of the present disclosure.

FIG. 3 illustrates an exemplary block diagram of a system 100 for enabling blockchain based transaction authorization based on a verification of an authenticating device without relying on a user device, in accordance with an embodiment of the present disclosure.

FIG. 4 illustrates an exemplary block diagram of a system 100 for enabling blockchain based transaction authorization by transferring an authorization token, in accordance with an embodiment of the present disclosure.

FIG. 5 illustrates an exemplary block diagram of a system 100 for enabling blockchain based transaction authorization by exchanging a cryptogram, in accordance with an embodiment of the present disclosure.

FIG. 6 illustrates an example flow chart for implementing a method 600 for enabling blockchain based transaction authorization, in accordance with an embodiment of the present disclosure.

FIG. 7 illustrates an exemplary computer system 700 in which or with which embodiments of the present disclosure can be utilized, in accordance with embodiments of the present disclosure.

The foregoing shall be more apparent from the following more detailed description of the present disclosure.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a system and a method for enabling blockchain based transaction authorization, which offers remote access, control, and authorization to smart cards using a Distributed Ledger Technology (DLT). The system empowers users to authorize multiple payment authorizations without a need to synchronize an authenticating device. The system may provide feasibility to enable support for multiple user account identifiers on a single authenticating device. The system empowers the users to choose and switch between DLTs. The system effectively permits distributed ledger transactions and reduces Point-of-Sale (POS) terminal error warnings, thereby providing a cost-effective and time-effective solution for enabling blockchain based transaction authorization.

The system may not require frequent updating mechanism to the authenticating device. The system may be configured to enable payment or transaction authorization based on the DLT via existing network and infrastructure of Europay Mastercard Visa (EMV) standard. The system may include the authenticating device, a terminal device, a user device, and a verification module. The method may include receiving, at the authenticating device, a request for transaction authorization from the terminal device, and generating a transaction including a source identifier, a destination identifier, a transaction value, and authorization data in a form of a digital signature. The system and the method may identify a mechanism to allow authorizing the transaction without limiting the value associated with the transaction. Due to an evolution of online services based on digital signatures (DLT is one such example of evolution) to meet multiple usage scenarios. The authenticating device may support multitude of services. Therefore, the system enables support of interoperability of the services leveraging the existing infrastructure of EMV standard and its technical protocol.

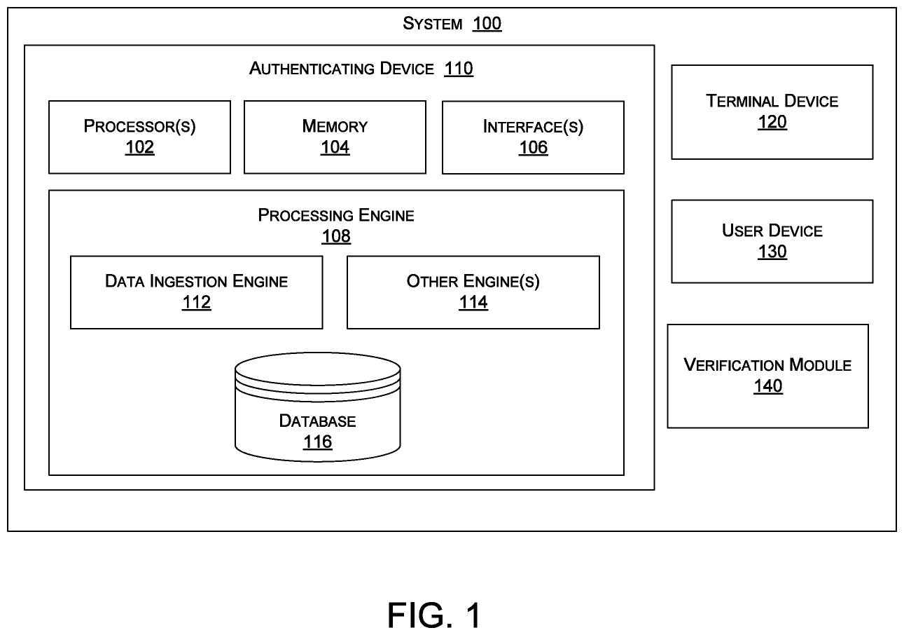

Various embodiments of the present disclosure will be explained in detail with reference to FIGS. 1-7.

FIG. 1 illustrates an example block diagram of a system 100 for enabling blockchain based transaction authorization, in accordance with an embodiment of the present disclosure.

With reference to FIG. 1, the system 100 may include an authenticating device 110, a terminal device 120, a user device 130, and a verification module 140. The authenticating device 110, the terminal device 120, and the user device 130 may be associated with the verification module 140. The authenticating device 110 may be, for example, but not limited to, a smart card. The authenticating device 110 may be made configurable to support an Europay, Mastercard, and Visa (EMV) standard that defines an electronic protocol (or a technical protocol) to enable the transaction authorization. The authenticating device 110 may be configured by interacting with or without the user device 130.

In an embodiment, the user device 130 may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users and/or entities, or any combination thereof.

A person of ordinary skill in the art will appreciate that the user device 130 may include, but is not limited to, intelligent, multi-sensing, network-connected devices, that can integrate seamlessly with each other and/or with a central server or a cloud-computing system or any other device that is network-connected.

In an embodiment, the user device 130 may include, but is not limited to, a handheld wireless communication device (e.g., a mobile phone, a smartphone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user device 130 may include, but is not limited to, any electrical, electronic, electromechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device. The user device 130 may include one or more in-built or externally coupled accessories including, but not limited to, a visual aid device such as a camera, an audio aid, a microphone, a keyboard, and input devices for receiving input from the user or an entity such as a touch pad, a touch enabled screen, an electronic pen, and the like. A person of ordinary skill in the art will appreciate that the user device 130 may not be restricted to the mentioned devices and various other devices may be used.

In an embodiment, and as shown in FIG. 1, the authenticating device 110 may include one or more processors 102. The one or more processors 102 may be implemented as one or more microprocessors, microcomputers, microcontrollers, digital signal processors, central processing units, logic circuitries, and/or any devices that manipulate data based on operational instructions. Among other capabilities, the one or more processor(s) 102 may be configured to fetch and execute computer-readable instructions stored in a memory 104 of the authenticating device 110. The memory 104 may store one or more computer-readable instructions or routines, which may be fetched and executed to generate or share the data units over a network service. The memory 104 may comprise any non-transitory storage device including, for example, volatile memory such as Random-Access Memory (RAM), or non-volatile memory such as Erasable Programmable Read-Only Memory (EPROM), flash memory, and the like.

In an embodiment, the authenticating device 110 may also include an interface(s) 106. The interface(s) 106 may comprise a variety of interfaces, for example, interfaces for data input and output devices, referred to as I/O devices, storage devices, and the like. The interface(s) 106 may facilitate communication of the authenticating device 110 with various devices coupled to it. The interface(s) 106 may also provide a communication pathway for one or more components of the authenticating device 110. Examples of such components include, but are not limited to, processing engine(s) 108 and a database 116.

In an embodiment, the processing engine(s) 108 may be implemented as a combination of hardware and programming (for example, programmable instructions) to implement one or more functionalities of the processing engine(s) 108. In examples, described herein, such combinations of hardware and programming may be implemented in several different ways. For example, the programming for the processing engine(s) 108 may be processor-executable instructions stored on a non-transitory machine-readable storage medium and the hardware for the one or more processors 102 may comprise a processing resource (for example, one or more processors), to execute such instructions. In the present examples, the machine-readable storage medium may store instructions that, when executed by the processing resource, implement the processing engine(s) 108. In such examples, the authenticating device 110 may comprise the machine-readable storage medium storing the instructions and the processing resource to execute the instructions, or the machine-readable storage medium may be separate but accessible to the authenticating device 110 and the processing resource. In other examples, the processing engine(s) 108 may be implemented by an electronic circuitry.

In an embodiment, the database 116 may include data that may be either stored or generated as a result of functionalities implemented by any of the components of the processor(s) 102 or the processing engine(s) 108 or the authenticating device 110.

In an exemplary embodiment, the processing engine(s) 108 may include one or more engines selected from any of a data ingestion engine 112 and other units/engines 114. The other units/engines 114 may include, but are not limited to, a data acquisition engine, a monitoring engine, a notification engine, a determination engine, and the like.

In an embodiment, the processor 102 may establish a connection between the authenticating device 110 and the terminal device 120. In response to establishing the connection between the authenticating device 110 and the terminal device 120, the processor 102 may, via the data ingestion engine 112, receive a request for transaction authorization from the terminal device 120. The request may include a plurality of credentials pertaining to transaction information. The plurality of credentials may include, but not limited to, a plurality of data object values indicative of the transaction information, and seed data for autonomously generating at least a first component and a second component of a digital signature. The seed data may be stored in the database 116 associated with the authenticating device 110.

In an embodiment, the processor 102 may, via the data ingestion engine 112, autonomously generate the first component and the second component of a digital signature, based on the seed data. The first component may be a r-component, and the second component may be a s-component, an authorization cryptogram, or an authorization token. In an embodiment, the processor 102 may, via the data ingestion engine 112, encapsulate the second component into one or more discretionary data fields of a data object. The data object may be compatible with the EMV technical protocol or an EMV communication protocol.

In an embodiment, the first component and the second component of the digital signature used to authorise the transactions on a DLT may be compressed to fit an available space in an EMV communication protocol. In an embodiment, a new signature scheme may be used where the first component and the second component of the digital signature utilise less space in order to fit them within the available space in the EMV communication protocol.

In an embodiment, the processor 102 may, via the data ingestion engine 112, generate a transaction with a source identifier, a destination identifier, a transaction value, and authorization data in the form of the digital signature based on the plurality of credentials. The digital signature may be generated by combining the first component and the encapsulated second component.

In an embodiment, the processor 102 may, via the data ingestion engine 112, transmit the digital signature to the verification module 140 associated with the authenticating device 110. The verification module 140 may authorize the digital signature by processing and verifying the digital signature. In an embodiment, the processor 102 may, via the data ingestion engine 112, transmit the digital signature to at least one online service (e.g., DLT service) and enable the at least one online service to transmit the digital signature to the terminal device 120. The terminal device 120 may determine a status of the transaction and transmit the status of the transaction to the processor 102. The processor 102 may, via the data ingestion engine 112, receive the status of the transaction from the terminal device 120.

Although FIG. 1 shows exemplary components of the system 100, in other embodiments, the system 100 may include fewer components, different components, differently arranged components, or additional functional components than depicted in FIG. 1. Additionally, or alternatively, one or more components of the system 100 may perform functions described as being performed by one or more other components of the system 100.

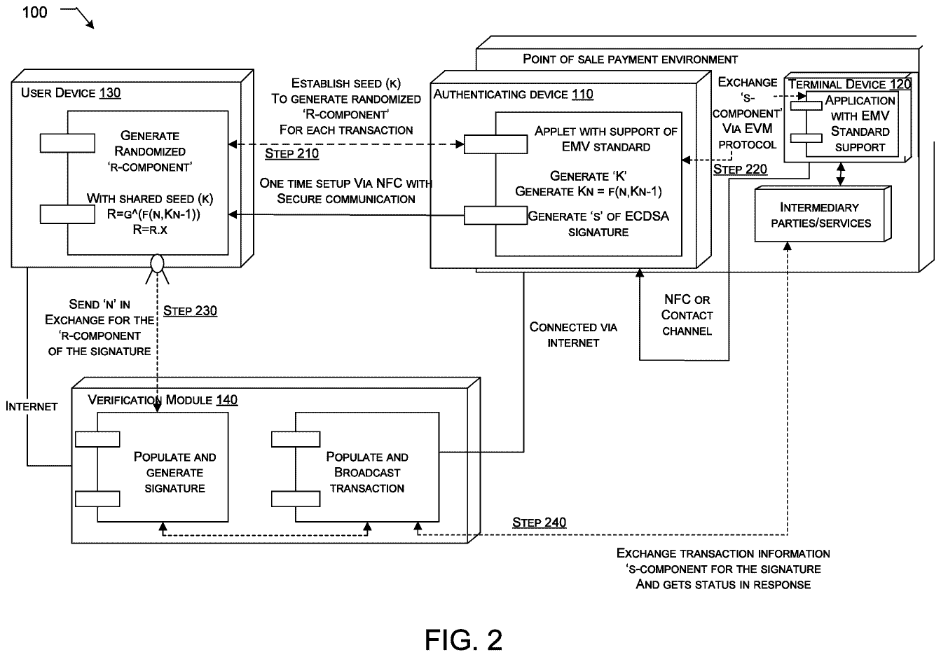

FIG. 2 illustrates an exemplary block diagram of a system 100 for enabling blockchain based transaction authorization based on a verification of an authenticating device 110 by relying on a user device 130, in accordance with an embodiment of the present disclosure.

With reference to FIG. 2, the system 100 may include the user device 130, the authenticating device 110, a terminal device 120, and a verification module 140. The system 100 may be configured to support multiple DLTs with means to allow choice or switching between the supported DLTs. The system 100 may provide a mechanism to encapsulate one or more components of a transaction, i.e., a digital signature into the discretionary fields of the EMV technical protocol. The discretionary fields may be limited by a size, and hence the system 100 may transfer necessary fields under such constraints. The one or more components may include, but not limited to, a r-component and a s-component. The s-component may be an authorization cryptogram or an authorization token. The authorization cryptogram generated by the authenticating device 110 may be a part of the DLT authorization cryptogram (a part of digital signature) or an alternative authentication mechanism to enable other services for verifying the authenticating device 110, and prepare the transaction data on behalf of the authentication device 110.

In an embodiment, the user device 130 may pertain to a computing device along with a software application at an end-user side. For instance, the user device 130 may include, but not limited to, a smartphone, a tablet, and the likes. The authenticating device 110 may be configured to support EMV standard which define a technical protocol to enable payment authorization. The terminal device 120 may be configured to generate the request for payment to be authorized. The terminal device 120 may adapt the EMV standard in its present form which is widely in use. The terminal device 120 may include, but not limited to a Point of Sale (POS) terminal, a card reader, and the likes. Further, the verification module 140 may be configured to process and verify the digital signature generated by the authenticating device 110.

In an embodiment, the terminal device 120 may be configured to initiate a configuration process to support DLT transactions on the existing infrastructure of the EMV standard. The configuration process may incorporate and share sufficient information to the authenticating device 110 to make the authenticating device 110 operational. The configuration process may be performed by utilizing the user device 130 which has a capability to communicate with the authenticating device 110 and support the configuration process. Since the configuration process is performed at the end-user side, the user device 130 may be configured to support the configuration process. For example, the user device 130 may be a smartphone running a software application to provide support for the configuration process. The configuration process may involve an interaction of the authenticating device 110 with the verification module 140. The configuration process may also perform necessary registration of the authenticating device 110 with the verification module 140 without which the authenticating device 110 may not be recognized as a valid system. Optionally, the configuration process may be initiated prior to the user receiving the authenticating device 110, i.e., the user may not have to do the process on their own. In an embodiment, the authenticating device 110 may support multiple DLTs which can be configured by the users. The authenticating device 110 may require a one-time configuration, and may perform a re-configuration which essentially performs the configuration step again after the first one on the authentication device 110.

In another embodiment, the authentication device 110 may perform an authorization process. During the authorization process, the authentication device 110 may provide the DLT service, and the valid digital signature may be split into two individual components. A first component of the digital signature may be termed as a r-component, and a second component may be referred as a s-component. The authorization process may involve the user device 130, the authenticating device 110, the terminal device 120, and the verification module 140. The terminal device 120 may be configured to prepare data objects including fields containing the information related to the payment or the transaction. The authenticating device 110 may respond with an authorization cryptogram contained/encapsulated in the discretionary field of the EMV standard data object. The authorization cryptogram may be the second component of the digital signature (also known as s-component or authorization token) to enable verification of the authenticating device 110.

As illustrated in FIG. 2, the user device 130 and the authenticating device 110 may be synchronized based on a one-time setup via a Near-field communication (NFC) with secure communication. The user device 130 may enable the configuration process to incorporate the relevant information on the authenticating device 110, and to enable a particular type of DLT. At step 210, the user device 130 may configure seed data required for random number generation of the r-component. For instance, generate ‘K’, generate Kn=f(n,Kn-1), which may be assumed to be exchanged in the configuration process. The technical protocol defined in Bitcoin Improvement Proposal-32 (BIP-32) standard may enable a mechanism for generating the r-component (first component of the digital signature). The seed data for BIP-32 (also called as entropy) generated may be exchanged between the user device 130 and the authenticating device 110.

At step 220, the authenticating device 110 may generate a s-component (second component of the digital signature). The s-component may be exchanged to the terminal device 120 via the technical protocol compatible with the EVM standard. The s-component may be encapsulated into discretionary data fields of a data object compatible with the EVM standard.

At step 230, the user device 130 in association with the authenticating device 110 may perform the authorization process by transferring the r-component and the encapsulated s-component to the verification module 140. Further, the verification module 140 may generate the digital signature by combining the r-component and the encapsulated s-component. The r-component and the encapsulated s-component may be routed over the EMV infrastructure to generate and authorize the digital signature.

At step 240, in response to the authorization process, the digital signature may be transmitted to an online service associated with the terminal device 120. Further, the digital signature may be transmitted to the terminal device 120 via a same communication channel to determine a status of the transaction. The status of the transaction may be then exchanged to the authenticating device 110 via the verification module 140.

The communication channel may be, for example, a communication network (also known as an internet). The communication network may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network may include, by way of example but not limitation, one or more of: a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, some combination thereof.

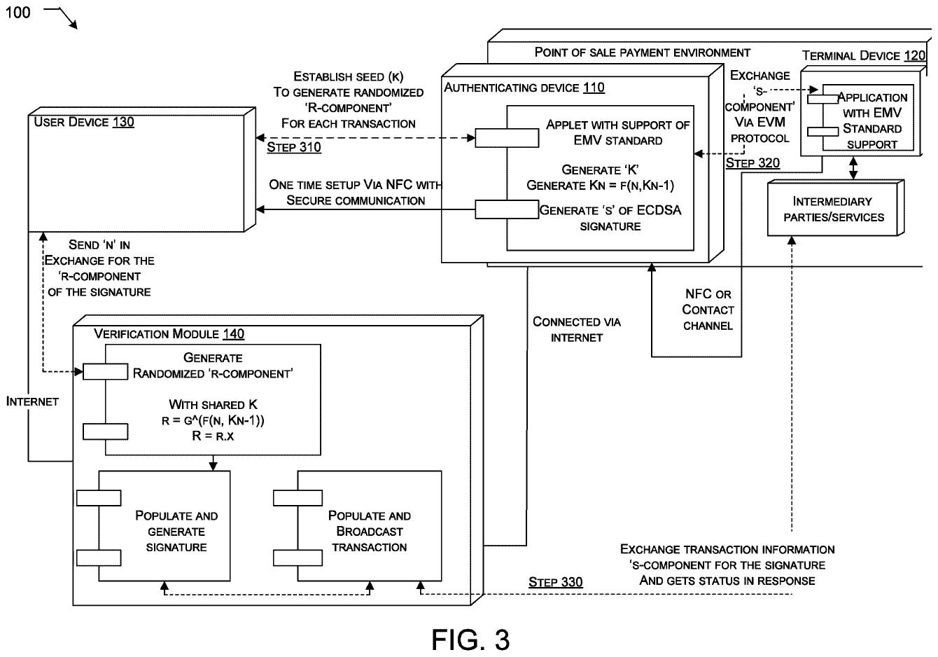

FIG. 3 illustrates an exemplary block diagram of a system 100 for enabling blockchain based transaction authorization based on a verification of an authenticating device 110 without relying on a user device 130, in accordance with an embodiment of the present disclosure.

With reference to FIG. 3, at step 310, the authenticating device 110 may generate the seed data during configuration and send the seed data to a verification module 140 via a communication channel. The authenticating device 110 may store the seed data in a database associated with the authenticating device 110. Further, the authenticating device 110 may generate a r-component and exchange the r-component to the verification module 140. Optionally, the generation of the seed data may be performed prior to receiving the authentication device 110 by the user. The configuration process may be repeated if the system 100 permits considering the flexibility needed by the user.

At step 320, the authenticating device 110 may generate a s-component (cryptogram) and exchange the s-component with the terminal device 120 via a technical platform compatible with the EMV standard. During the authorization process, the authenticating device 110 may transmit the s-component (cryptogram) to the verification module 140. The verification module 140 may identify the authenticating device 110 and locate the seed data stored in the authenticating device 110. In an embodiment, the verification module 140 may be configured to utilize the seed data and BIP-32 algorithm to generate the r-component. The verification module 140 may combine the r-component and the s-component to generate a digital signature that would be specific to the DLT.

At step 330, the digital signature may be sent to the online service which is associated with the terminal device 120 to determine a status of the transaction. The status of the transaction may be sent to the terminal device 120 via the same communication channel. In response, the terminal device 120 may transmit the status of the transaction to the authenticating device 110.

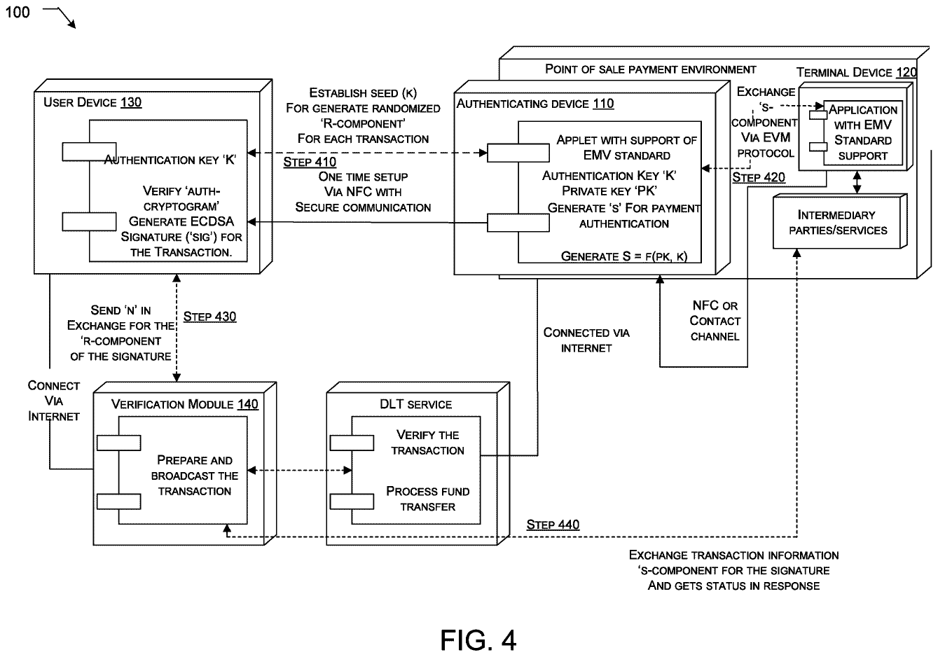

FIG. 4 illustrates an exemplary block diagram of a system 100 for enabling blockchain based transaction authorization by transferring an authorization token, in accordance with an embodiment of the present disclosure.

With reference to FIG. 4, at 410, a user device 130 may configure seed data required for random number generation of an authorization token. The configuration process may establish a shared key between the authenticating device 110 and the user device 130. The shared key may be generated by a technical protocol agreed between the authenticating device 110 and a verification module 140.

At 420, the authenticating device 110 may generate an authentication key, a private key, and a s-component based on the authentication key and the private key. The s-component may be exchanged to a terminal device 120 via the technical protocol compatible with an EMV standard.

At 430, the user device 130 and the authenticating device 110 may communicate with the verification module 140, and exchange the r-component and the s-component to the verification module 140, respectively. The s-component may be encapsulated in the discretionary field of the EMV data object. The verification module 140 may verify and combine the r-component and the encapsulated s-component. The verification module 140 may generate a digital signature as a result of successful verification. The verification module 140 may verify the authenticating device 110, based on the information received from the user device 130 during the configuration process.

At 440, the verification module 140 may send the digital signature to an online service (e.g., DLT service) associated with the terminal device 120 to determine a status of the transaction. The status of the transaction may be transferred to the terminal device 120. Finally, the status of the transaction may be transmitted to the authenticating device 110.

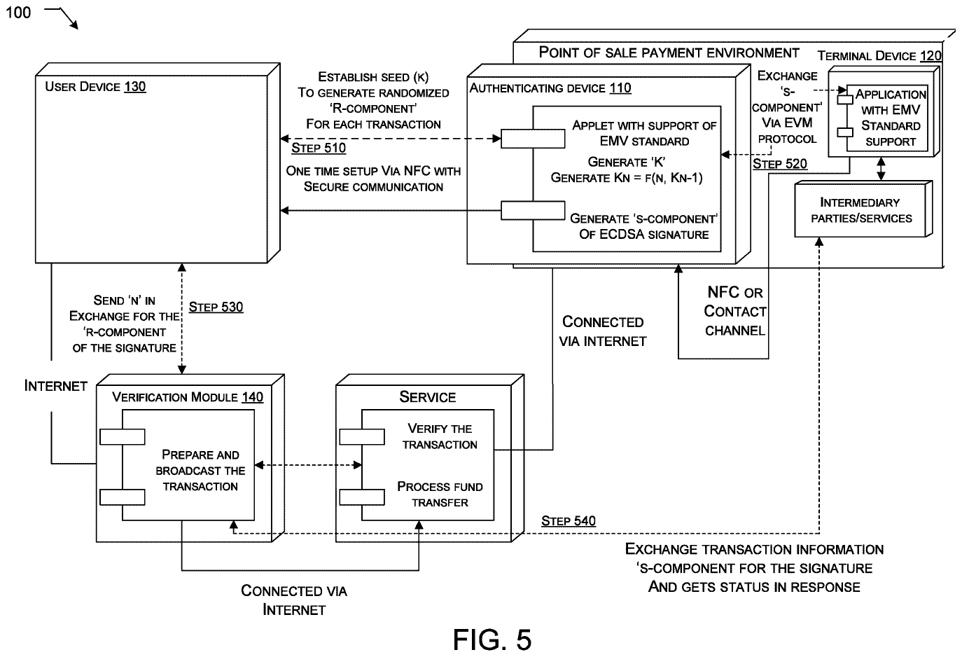

FIG. 5 illustrates an exemplary block diagram of a system 100 for enabling blockchain based transaction authorization by exchanging a cryptogram, in accordance with an embodiment of the present disclosure.

With reference to FIG. 5, at step 510, an authenticating device 110 may configure seed data required for random number generation of transaction approval cryptogram. The authenticating device 110 may generate the cryptogram using the seed data. The cryptogram (s-component) may be encapsulated in the discretionary data fields of a data object compatible with an EMV standard. Further, the authenticating device 110 may also generate a r-component and exchange the r-component to a verification module 140.

At 520, an online service (DLT service) may be programmed with a custom verification algorithm such that the cryptogram (s-component) may fit in discretionary data fields of the data object compatible with the EMV standard. The cryptogram may be exchanged with a terminal device 120 via a technical protocol.

At 530, the verification module 140 may receive and verify the r-component and the cryptogram. Further, the verification module 140 may create a digital signature by combining the r-component and the cryptogram.

At 540, the verification module 140 may send the digital signature to an online service (e.g., DLT service) associated with the terminal device 120 to determine a status of the transaction. The status of the transaction may be transferred to the terminal device 120. Finally, the status of the transaction may be transmitted to the authenticating device 110.

Although the present disclosure refers to the DLT service as the only use-case of digital signatures generated by the authenticating device 110, it may be noted that the target/use-case of the present disclosure is not limited as such. The proposed disclosure aims to connect any online service leveraging digital signatures with the existing infrastructure of the EMV standard.

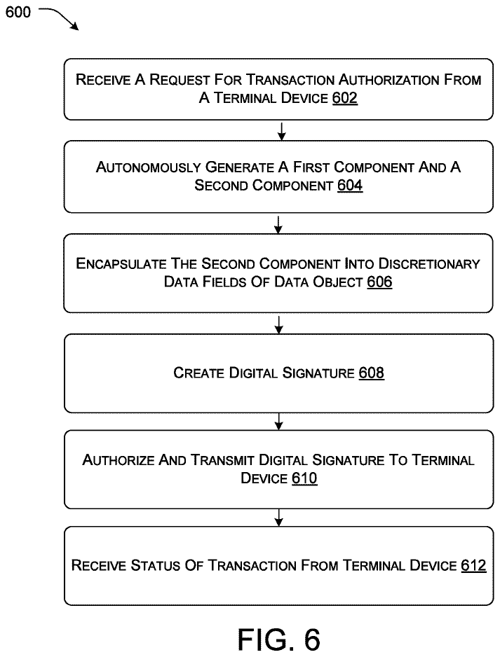

FIG. 6 illustrates an example flow chart for implementing a method 600 for enabling blockchain based transaction authorization, in accordance with an embodiment of the present disclosure.

With reference to FIG. 6, at 602, the method 600 may include receiving a request for transaction authorization from a terminal device 120, where the request may include a plurality of credentials pertaining to transaction information. At 604, the method 600 may include autonomously generating a first component (r-component) and a second component (a s-component, an authorization cryptogram, or an authorization token), based on the plurality of credentials.

At 606, the method 600 may include encapsulating the second component into one or more discretionary data fields of a data object compatible with an EMV standard. At 608, the method 600 may include generating a digital signature by combining the first component and the encapsulated second component. At 610, the method 600 may include authorizing and transmitting the digital signature to the terminal device 120 to determine a status of a transaction. At 612, the method 600 may include receiving the status of the transaction from the terminal device 120.

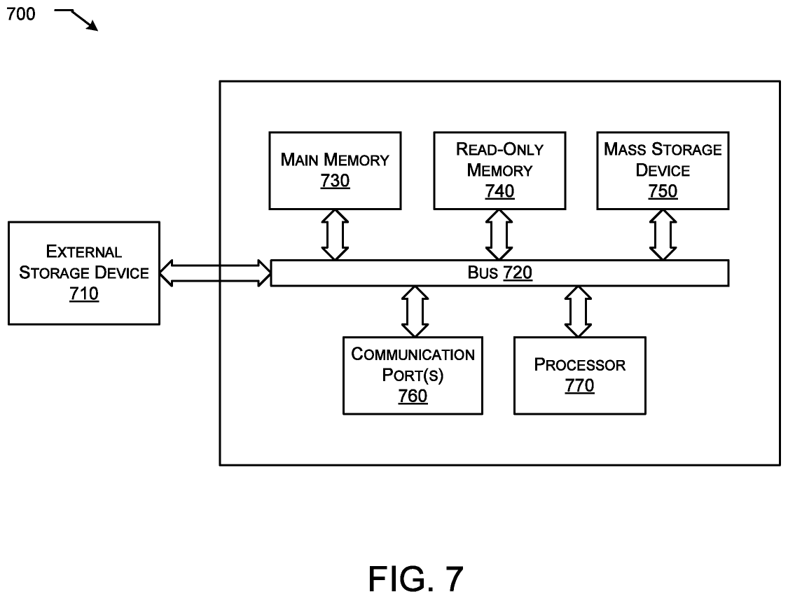

FIG. 7 illustrates an exemplary computer system 700 in which or with which embodiments of the present disclosure can be utilized, in accordance with embodiments of the present disclosure.

As shown in FIG. 7, the computer system 700 may include an external storage device 710, a bus 720, a main memory 730, a read only memory 740, a mass storage device 750, communication port 760, and a processor 770. A person skilled in the art will appreciate that the computer system 700 may include more than one processor and communication ports. Examples of processor 770 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 770 may include various modules associated with embodiments of the present disclosure.

The communication port 760 may be any of an RS-232 port for use with a modem-based dialup connection, a 10/100 Ethernet port, a Gigabit or 10 Gigabit port using copper or fiber, a serial port, a parallel port, or other existing or future ports. The communication port 760 may be chosen depending on a network, such a Local Area Network (LAN), Wide Area Network (WAN), or any network to which the computer system 700 connects.

The memory 730 may be a Random Access Memory (RAM), or any other dynamic storage device commonly known in the art. The read-only memory 740 may be any static storage device(s) e.g., but not limited to, a Programmable Read Only Memory (PROM) chips for storing static information e.g., start-up or BIOS instructions for the processor 770. The mass storage 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, and Redundant Array of Independent Disks (RAID) storage.

The bus 720 communicatively couples the processor(s) 770 with the other memory, storage and communication blocks. The bus 720 may be, e.g. a Peripheral Component Interconnect (PCI)/PCI Extended (PCI-X) bus, Small Computer System Interface (SCSI), USB, or the like, for connecting expansion cards, drives and other subsystems as well as other buses, such a front side bus (FSB), which connects the processor 770 to a software system.

Optionally, operator and administrative interfaces, e.g. a display, keyboard, and a cursor control device, may also be coupled to the bus 720 to support direct operator interaction with the computer system 700. Other operator and administrative interfaces can be provided through network connections connected through the communication port 760. The external storage device 710 may be any kind of external hard-drives, floppy drives, Zip Drives, Compact Disc-Read Only Memory (CD-ROM), Compact Disc-Re-Writable (CD-RW), and Digital Video Disk-Read Only Memory (DVD-ROM). Components described above are meant only to exemplify various possibilities. In no way should the aforementioned exemplary computer system 700 limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Present Disclosure

The present disclosure provides a system and a method for enabling blockchain based transaction authorization, which offers remote access, control, and authorization to the smart cards using a Distributed Ledger Technology (DLT).

The present disclosure empowers users to authorize multiple payment authorizations without a need to synchronize an authenticating device.

The present disclosure provides feasibility to enable support for multiple user account identifiers on a single authenticating device.

The present disclosure empowers users to choose and switch between DLTs, effectively permits distributed ledger transactions, and reduces Point-of-Sale (POS) terminal error warnings.

The present disclosure provides a cost-effective and time-effective solution for enabling blockchain based transaction authorization.

1. A system for enabling blockchain based transaction authorization, wherein the system comprises an authenticating device comprising:
one or more processors; and
a memory operatively coupled to the one or more processors, wherein the memory comprises processor-executable instructions, which on execution, cause the one or more processors to:
receive a request for transaction authorization from a terminal device, wherein the request comprises a plurality of credentials pertaining to transaction information;
autonomously generate at least a first component and a second component of a digital signature, based on the plurality of credentials;
encapsulate the second component into one or more discretionary data fields of a data object;
generate the digital signature by combining the first component and the encapsulated second component;
authorize and transmit the digital signature to the terminal device to determine a status of a transaction; and
receive the status of the transaction from the terminal device.

2. The system as claimed in claim 1, wherein the one or more processors are to receive the request for transaction authorization from the terminal device in response to establishing a connection between the authenticating device and the terminal device.

3. The system as claimed in claim 1, wherein the authenticating device is made configurable to support an Europay, Mastercard, and Visa (EMV) standard that defines an electronic protocol to enable the transaction authorization.

4. The system as claimed in claim 1, wherein the plurality of credentials comprises a plurality of data object values indicative of the transaction information, and seed data for autonomously generating at least the first component and the second component, and wherein the seed data is stored in a database associated with the authenticating device.

5. The system as claimed in claim 1, wherein the one or more processors are to authorize the digital signature by being configured to process and verify the digital signature, via a verification module, based on information received during configuration of the authenticating device.

6. The system as claimed in claim 1, wherein the one or more processors are to transmit the digital signature to the terminal device by being configured to transmit the digital signature to at least one online service and enable the at least one online service to transmit the digital signature to the terminal device.

7. The system as claimed in claim 1, wherein the data object is compatible with an EMV technical protocol.

8. The system as claimed in claim 1, wherein the first component is a r-component, and the second component is one of: a s-component, an authorization cryptogram, or an authorization token.

9. The system as claimed in claim 1, wherein the digital signature is transmitted to the at least one online service via a communication channel.

10. A method for enabling blockchain based transaction authorization, the method comprising:
receiving, by one or more processors associated with an authenticating device, a request for transaction authorization from a terminal device, wherein the request comprises a plurality of credentials pertaining to transaction information;
autonomously generating, by the one or more processors, at least a first component and a second component of a digital signature, based on the plurality of credentials;
encapsulating, by the one or more processors, the second component into one or more discretionary data fields of a data object;
generating, by the one or more processors, the digital signature by combining the first component and the encapsulated second component;
authorizing and transmitting, by the one or more processors, the digital signature to the terminal device to determine a status of a transaction; and
receiving, by the one or more processors, the status of the transaction from the terminal device.
